(19) United States
(12) Patent Application Publication
(10) Pub. No.: US 2017/0123486 A1
(43) Pub. Date: May 4, 2017

(54) SERIES OFFSET CAPACITOR FOR INTERNAL REFERENCE BASED CAPACITIVE SAMPLING

(71) Applicant: CIRQUE CORPORATION, Salt Lake City, UT (US)

(72) Inventors: David Willis, Murray, UT (US); Paul Vincent, Kaysville, UT (US); Brent Quist, Bountiful, UT (US); Wayne Liu, Sandy, UT (US); Eric Gibson, Lehi, UT (US)

(21) Appl. No.: 15/341,794

(22) Filed: Nov. 2, 2016

Related U.S. Application Data
(60) Provisional application No. 62/249,503, filed on Nov. 2, 2015.

(51) Int. Cl. G06F 1/32; G06F 3/041; G06F 3/044

(52) U.S. Cl. CPC G06F 1/3296; G06F 3/044; G06F 3/0416; G06F 2203/04108

(57) ABSTRACT

A system and method for reducing the power required for a capacitive sensing measurement and for simplifying a sample capacitor signal offset while reducing charge injection during synchronous rectification by enabling the touch sensor to begin a measurement cycle at an arbitrary voltage rather than forcing the touch sensor to have a precise known voltage.

### BACKGROUND OF THE INVENTION

Field Of the Invention:

This invention relates generally to touch sensors that use capacitance sensing technology. Specifically, the invention pertains to a system and method that simplifies a sample offset while reducing charge injection during synchronous rectification.

Description of the Prior art:

There are several designs for capacitance sensitive touch sensors which may take advantage of a system and method of the invention. It is useful to examine the underlying technology of the touch sensors to better understand how any capacitance sensitive touchpad can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

It should be understood that use of the term “touch sensor” throughout this document may be used interchangeably with “forcepad”, “touchpad”, “proximity sensor”, “touch and proximity sensor”, “touch panel” and “touch screen”.

### BRIEF SUMMARY OF THE INVENTION

In a first embodiment, the present invention is a system and method for reducing the power required for a capacitive sensing measurement and for simplifying a sample capacitor signal offset while reducing charge injection during synchronous rectification by enabling the touch sensor to begin a measurement cycle at an arbitrary voltage rather than forcing the touch sensor to have a precise and known voltage.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

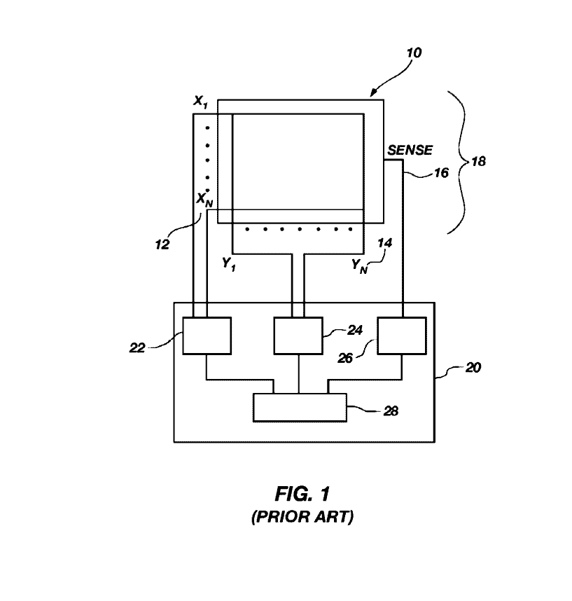

FIG. 2 is an electrical circuit diagram of a first embodiment of the invention.

FIG. 3 is an electrical circuit diagram of a touch sensor that incorporates the second embodiment of the invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Previous solutions for operating a touch sensor relied on the touch sensor circuits being forced to a known initial condition or state. More specifically, a touch sensor may have been driven to a specific voltage in order to obtain a repeatable initial condition before making a measurement. Disadvantageously, this approach of forcing the circuit to a known initial condition may take a great deal of power and precision. Power may be wasted when operating off of a battery, and cost of the circuitry may increase if the circuit must always be driven to a precise initial voltage condition.

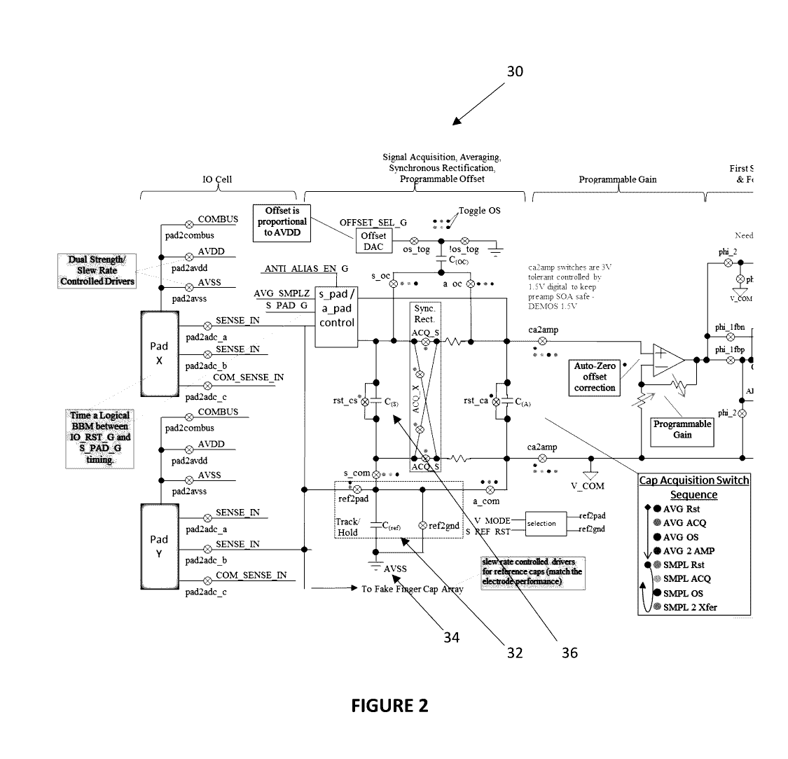

FIG. 2 is a first iteration or first embodiment of the invention. FIG. 2 shows a signal sampling circuit This figure shows that the C(ref) 32 is placed between AVSS 34 and the C(S) sample capacitor 36. One of the problems with this circuit design or topology is that when the signal is re-referenced to V_COM, it has to overcome a non-deterministic offset. The first embodiment may also work in conjunction with a charge sharing circuit to set the initial voltage conditions using no active amplifiers.

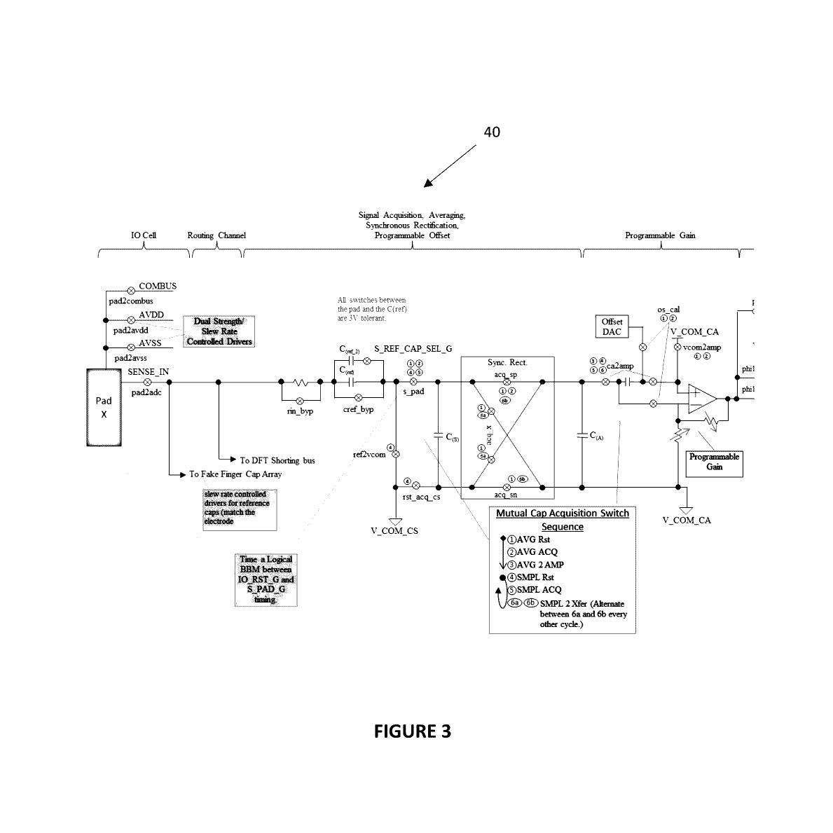

FIG. 3 shows a second embodiment of the invention. This second embodiment of a signal sensing circuit 40 enables a touch sensor to begin a measurement cycle at an arbitrary voltage rather than at a precise known voltage.

The first and second embodiments may be designed to reduce power consumption of the touch sensor by not having to expend power to force the capacitive sensing signal sampling circuit to an initial voltage. Thus, when measuring a sample voltage from at least one sense electrode, the signal sampling circuit is not forced to some predetermined initial condition having a known voltage. Instead, the signal sampling circuit may be allowed to operate from whatever voltage is already present on the circuit.

The first and second embodiments are both a system and a method of operation. The circuits shown in FIGS. 2 and 3 should only be considered to be examples of circuits that may be used to accomplish the purposes of the invention, and should not be considered as limiting other possible circuit designs.

A first purpose of the embodiments is to reduce power consumption of any capacitive sensing touch sensor. The touch sensor may include the electrodes that are used to form a touch sensing surface, as well as any touch sensing circuitry that sends and receives signals from the electrodes in the touch sensing surface.

A first step of a method of at least one embodiment may be to provide a plurality of electrodes disposed in an orthogonal and co-planar array of two sets of electrodes, wherein the two sets of electrodes always perform different functions from each other, switching between a drive function and a sense function. Thus, when a first set of electrodes functions as drive electrodes, the second set of electrodes may function as the sense electrodes. The functions of the electrodes may then be switched in order to determine a position of an object on the touch sensor surface in both axes of the two sets of electrodes.

A next step of the method may be to provide a touch controller that transmits drive signals to the plurality of electrodes that are functioning as drive electrodes. The touch controller may also receive sense signals from the other plurality of electrodes that are functioning as the sense electrodes. The touch controller may also include a signal sampling circuit for receiving the sense signals.

The embodiments of the invention may be directed to improvements in the signal sampling circuit of the touch controller. In a typical capacitance sensitive signal sampling circuit, it may be necessary to drive a sampling capacitor to a predetermined and precisely set voltage. Driving the sampling capacitor to a predetermined voltage may take a significant amount of current which must be taken from whatever power source is supplying power. When operating in a battery operated device, the power consumption may be significant. The embodiments of the invention may eliminate the need to drive the sampling capacitor to the predetermined voltage by enabling the signal sampling circuit to use whatever voltage just happens to already be present on the signal sampling circuit. The signal sampling circuit may operate using any voltage that is present.

Therefore, when the signal sampling circuit is initialized, there is no longer any need to drive to a specific voltage, resulting in a power reduction. Tests have shown a 10× decrease in power consumption of the signal sampling circuit. Sense signals are receiving by the signal sampling circuit, and a position of an object on the two sets of electrodes is determined in one axis. It is then necessary to switch the functions of the sets of electrodes in order to determine the position of the object in the other axis of the electrodes.

Another benefit of this method may include a faster set-up time of the signal sampling circuit. There may no longer be a delay associated with waiting for the signal sampling circuit to charge to a predetermined voltage, so measurements may be taken more rapidly. A faster response time of the signal sampling circuit response may result in more rapid position determination.

Another benefit may be overall simplification of the signal sampling circuit. Not only do typical signal sampling circuits have to reach a predefined voltage, but also be precise in reaching that voltage. Any variation from the predetermined voltage may affect the accuracy of the position determination. The embodiments of the invention may now avoid that problem because the beginning voltage of the signal sampling circuit may now be arbitrary.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for reducing power consumption of a capacitive sensing touch sensor, said method comprising:
providing a plurality of electrodes disposed in an orthogonal and co-planar array of two sets of electrodes, wherein the two sets of electrodes always perform different functions from each other, switching between a drive function and a sense function;
providing a touch controller that transmits drive signals to the plurality of electrodes and which receives sense signals from the plurality of electrodes, wherein the touch controller includes a signal sampling circuit for receiving the sense signals;
initializing the signal sampling circuit by enabling the signal sampling circuit to use an arbitrary voltage that is present on the signal sampling circuit before receiving the sense signals;
receiving the sense signals by the signal sampling circuit; and
determining a position of at least one object in contact with the plurality of electrodes using the sense signals.

2. The method as defined in claim 1 wherein the step of initializing the signal sampling circuit further comprises not forcing the signal sampling circuit to a predetermined voltage, and thereby reducing power consumption by saving current that would otherwise be used by the signal sampling circuit to reach the predetermined voltage.

3. The method as defined in claim 2 wherein the step of initializing the signal sampling circuit further comprises reducing a set-up time for the signal sampling circuit to prepare for receiving the sense signals because the signal sampling circuit does not have to be forced to the predetermined voltage.

4. The method as defined in claim 2 wherein the method further comprises reducing components in the signal sampling circuit by eliminating circuitry that was used to drive the signal sampling circuit to the predefined voltage.

5. A method for simplifying a capacitive sensing touch sensor, said method comprising:
providing a plurality of electrodes disposed in an orthogonal and co-planar array of two sets of electrodes, wherein the two sets of electrodes always perform different functions from each other, switching between a drive function and a sense function;
providing a touch controller that transmits drive signals to the plurality of electrodes that are functioning as drive electrodes and which receives sense signals from the plurality of electrodes that are functioning as sense electrodes, wherein the touch controller includes a signal sampling circuit for receiving the sense signals;
initializing the signal sampling circuit by enabling the signal sampling circuit to use an arbitrary voltage that is present on the signal sampling circuit before receiving the sense signals;
receiving the sense signals by the signal sampling circuit; and
determining a position of at least one object on the plurality of electrodes using the sense signals.

6. The method as defined in claim 5 wherein the step of initializing the signal sampling circuit further comprises not forcing the signal sampling circuit to a predetermined voltage, and thereby reducing power consumption by saving current that would otherwise be used by the signal sampling circuit to reach the predetermined voltage.

7. The method as defined in claim 6 wherein the step of initializing the signal sampling circuit further comprises reducing a set-up time for the signal sampling circuit to prepare for receiving the sense signals because the signal sampling circuit does not have to be forced to the predetermined voltage.
